(19) United States
(12) Patent Application Publication
(10) Pub. No.: US 2026/0362250 A1
(43) Pub. Date: Nov. 12, 2026

(54) SERVING CELL AS ADDITIONAL CANDIDATE FOR MOBILITY MANAGEMENT

(71) Applicant: Apple Inc., Cupertino, CA (US)

(72) Inventors: Fangli XU, Beijing (CN); Naveen Kumar R Palle Venkata, San Diego, CA (US); Yuqin Chen, Beijing (CN); Haijing Hu, Los Gatos, CA (US); Ralf Rossbach, Munich (DE); Peng Cheng, Beijing (CN); Sethuraman Gurumoorthy, San Ramon, CA (US); Ping-Heng Kuo, London (GB)

(21) Appl. No.: 19/125,800

(22) PCT Filed: Nov. 3, 2022
(86) PCT No.: PCT/CN2022/129624

§ 371 Date: Apr. 30, 2025

(51) Int. Cl. H04W 36/00

(52) U.S. Cl. CPC H04W 36/0061; H04W 36/00692

(57) ABSTRACT

Techniques, described herein, include solutions for some aspects of configuration and signaling of the candidate cells or cell groups. After finishing a cell change, a User Equipment (UE) does not release and rather maintains candidate configurations of remaining candidate cells for subsequent cell change procedures. Also, a candidate configuration of the source cell or cell group may be added as an additional candidate configuration for subsequent cell change procedures, such that the source cell(s) can be reused if the UE moves back to corresponding coverage areas.

### FIELD

This disclosure relates to wireless communication networks, including techniques for using a serving node as a candidate node for mobility management such as L2 mobility or secondary node switch. Other aspects and techniques are also described.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a schematic diagram illustrating a cell change procedure using a source node as a candidate for subsequent cell changes of a user equipment (UE) in a wireless network system in accordance with some aspects of the present disclosure.

FIG. 2 is a schematic diagram illustrating a signaling example for a cell change procedure of L2 mobility applying candidate configuration techniques described herein in accordance with some aspects of the present disclosure.

FIG. 3 is a schematic diagram respectively illustrating a signaling example for a cell change procedure of SN switch applying candidate configuration techniques described herein in accordance with some aspects of the present disclosure.

FIG. 4 is a configuration example using an implicit indication in configuration information to include a serving cell candidate for a subsequent cell change in accordance with some aspects of the present disclosure.

FIG. 5 is an example of assigning fixed candidate configuration IDs to serving cell candidates in accordance with some aspects of the present disclosure.

FIG. 6 provides an example of assigning a dedicated candidate configuration ID to a serving cell candidate in accordance with some aspects of the present disclosure.

FIGS. 7A-7B illustrate examples of configurations for a serving cell and a candidate list for L2 mobility in accordance with some aspects of the present disclosure.

FIG. 8 illustrates another examples of configurations for a serving cell and a candidate list for SN switch in accordance with some aspects of the present disclosure.

FIG. 9 illustrates a further configuration example using an implicit indication in configuration information to include a serving cell candidate for a subsequent cell change in accordance with some aspects of the present disclosure.

FIG. 10 illustrates a configuration example using explicit candidate configurations for a serving cell candidate in accordance with some aspects of the present disclosure.

FIGS. 11-12 illustrate configuration examples using a hybrid of implicit and explicit candidate configurations for a serving cell candidate in accordance with some aspects of the present disclosure.

FIG. 13 is a schematic diagram illustrating signaling between a base station and a UE to communicate UE capability information for including a serving cell candidate in accordance with some aspects of the present disclosure.

FIG. 14 is a block diagram illustrating a device that can be employed to perform gapless UE measurements in accordance with some aspects of the present disclosure.

FIG. 15 is a block diagram illustrating baseband circuitry that can be employed to perform gapless UE measurements in accordance with some aspects of the present disclosure.

FIG. 16 is a process flow illustrating a cell change procedure for a UE to use a serving node as a candidate for subsequent cell changes in accordance with some aspects of the present disclosure.

FIG. 17 is a process flow illustrating a cell change procedure for a Base Station (BS) to configure a serving node as a candidate for subsequent cell changes is accordance with some aspects of the present disclosure.

### DETAILED DESCRIPTION

The present disclosure is described with reference to the attached figures. The like reference numerals are used to refer to like elements throughout. The figures are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

Wireless communication networks include mobile devices capable of communicating with base stations, which further connect the mobile devices to a core network or other network devices. The base stations include cells to support coverage of various geographical areas. The evolution of wireless communication calls for continuous enhancement of the robust mobility performance with low-latency and high reliability. Mobility management of mobile networks offers service continuity to moving devices. When a mobile device moves from a coverage area of one cell (referred as a source cell) to another cell (referred as a target cell), a cell change is sought in order to avoid link degradation or even termination. In some aspects, the cell change can be, for example, a handover from a source cell to a target cell, or a source node to a target node including switches of at least a Primary Cell (PCell). The cell change can also be, as another example, a Master Node (MN) switch or a Secondary Node (SN) switch for Dual Connectivity (DC) case.

The cell change is traditionally based on Layer 3 (L3) measurements and Radio Resource Control (RRC) signaling. In Release 18 of 3GPP, Layer 1 (L1)/Layer 2 (L2) based cell change without RRC reconfiguration is introduced, in order to reduce latency, overhead, and interruption time associated with the RRC signaling of the L3-based mobility management. During operation, L1/L2 measurement is performed and reported. If a mobility change condition is satisfied based on the L1/L2 measurement, a corresponding cell change action may be performed to switch from a serving cell to a target cell, or from a serving sell group to a target cell group. The target cell or the target cell group is selected from a list of candidate cells or cell groups configured by Network. Since the list of candidate cells or cell groups is not reconfigured for every L1/L2 based cell change, mechanisms of maintaining and/or updating the list of candidate cells or cell groups need to be studied.

Accordingly, some aspects of the present disclosure relate to configuration and signaling of the candidate cells or cell groups. After finishing a cell change, a User Equipment (UE) does not release and rather maintains candidate configurations of remaining candidate cells for subsequent cell change procedures. Also, a candidate configuration of the source cell or cell group may be added as an additional candidate configuration for subsequent cell change procedures, such that the source cell(s) can be reused if the UE moves back to corresponding coverage areas.

In some aspects, a serving configuration of the source cell or cell group is considered to be a candidate configuration. For example, the serving configuration of the source cell or cell group may always be assumed to be a candidate configuration, or may be assumed to be a candidate configuration only when the UE is so configured based on an implicit indicator from the Network. In some other aspects, the source cell or cell group is explicitly configured as a candidate by Network. In one example, the explicit configuration may identify a complete cell or cell group configuration as a candidate configuration. In another example, the explicit configuration may include a delta configuration in reference to the serving configuration of the source cell or cell group, and a candidate configuration can be derived from the delta configuration and the serving configuration. Additional aspects and details of the disclosure are further described below with reference to figures.

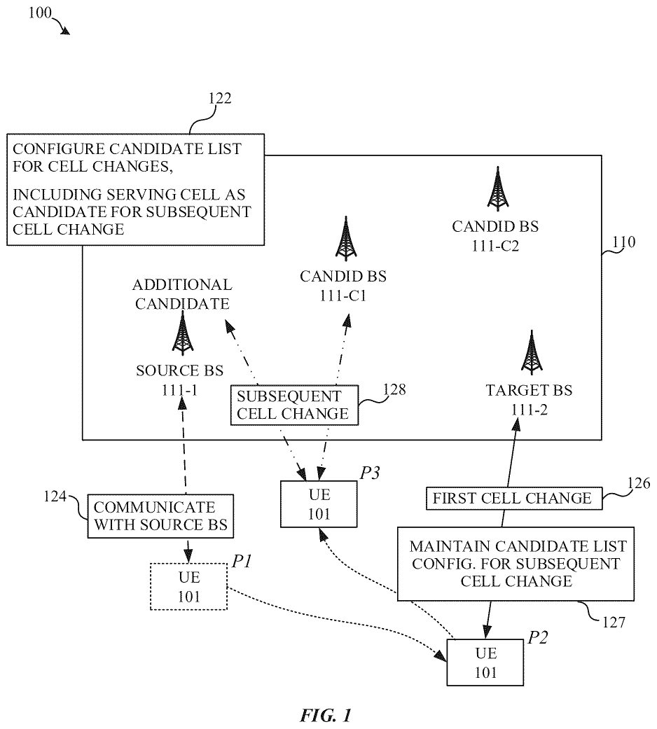

FIG. 1 provides an overview of a cell change procedure of a network system 100 in accordance with various aspects. The network system 100 includes a UE 101 and a Radio Access Network (RAN) 110. The UE 101 can be configured to connect, for example, communicatively couple, with the RAN 110. The RAN 110 may comprise one or more Base Stations (BSs, or access nodes), such as BSs 111-1, 111-2, 111-C1, 111-C2 as shown in FIG. 1.

As an example scenario for illustration purpose, the UE 101 is initially connected with a source BS 111-1 as shown by act 124. The UE 101 receives configuration information, including configurations of serving cell groups and candidate cells for mobility management, as shown by act 122. The configuration information may be transmitted by the source BS 111-1 or another BS such as a MN for a DC case. The configuration information may be transmitted via RRC signaling and then used by multiple subsequent cell change procedures without involving additional RRC reconfiguration. Thus, the configuration information is not only for a first cell change, but also for subsequent cell changes such as a L2 mobility change or a SN switch. As illustrated in more detail below, in some aspects, a serving configuration of a serving cell may be used as a candidate configuration for subsequent cell changes. In some alternative aspects, the serving configuration of the serving cell may be used as a reference of the candidate configuration, and a delta configuration is applied to the serving cell configuration, in order to derive the candidate configuration.

When the UE 101 moves away from a geographical coverage area of the source BS 111-1, for example, from a first location P1 to a second location P2 that is further away from the source BS 111-1, the UE 101 experiences link degradation because of its distance from the source BS 111-1. The second location P2 may be better covered by one or more other BSs, referred as candidate BSs. After performing measurements for the candidate BSs, a decision may be made to perform a first cell change to move the UE connection from the source BS 111-1 to a target BS 111-2, as shown by act 126. The target BS 111-2 is selected from a list of candidate BSs configured to the UE 101 using the configuration information provided at act 122.

As shown by act 127, after the first cell change at act 126, rather than releasing configurations for the remaining candidate BSs and receiving new candidate cell configurations, the UE 101 maintains the configuration information for the remaining candidate BSs and performs L1/L2 measurement and control/activation for a subsequent cell change, such that the latency, overhead, and interruption time associated with the RRC signaling of a L3-based mobility management is reduced. In addition, the source BS 111-1 may be added to the configuration information as an additional candidate for the subsequent cell change, such that the source BS 111-1 can be a new target cell for the subsequent cell change if conditions are met. In some aspects, the additional candidate configuration can use the same serving cell configuration of the source BS 111-1. In some further aspects, the additional candidate configuration can be based on the serving cell configuration of the source BS 111-1 as a reference, and apply configuration changes to derive a candidate configuration for the source BS 111-1. The derived candidate configuration is not accessible to the previous serving cell and thus can provide improved security.

When the UE 101 moves away from a geographical coverage area of the target BS 111-2, for example, from the second location P2 to a third location P3, the third location P3 may be better covered by one or more other candidate BSs. As described above, the one or more other candidate BSs may include previous serving cells as additional candidates, e.g., the previous source BS 111-1. After performing measurements for the candidate BSs, a decision may be made to perform the subsequent cell change to a new target BS selected from the candidate BSs configured to the UE 101, such as a candidate BS 111-C1 or the previous source BS 111-1.

As used herein, the term “UE”, “mobile device”, or the like can describe equipment that may comprise any wireless computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, Machine Type Communication (MTC) devices, Machine to Machine (M2M), Internet of Things (IoT) devices, and/or the like. The UE may be “mobile” or “wireless” in relative to access nodes or BSs of the RAN. The UE may be referred to as a processor and/or other parts of a device or equipment as a fixture of a movable carrier, and is not necessarily movable or free of communication wires itself.

As used herein, the terms “BS,” “access node,” “access point,” “Base Station,” or the like can describe an equipment that provides the radio baseband functions for data and/or voice connectivity between the RAN 110 and one or more users. The RAN 110 can operates in an NR or 5G system, an LTE or 4G system, and/or other legacy or advanced wireless systems. The access nodes in the RAN 110 can be inter Radio Access Technologies (RATs) and can be alternatively referred to as BSs, gNodeBs, gNBs, eNBs, eNodeBs, eNBs, RAN nodes, RSUs, Transmission Reception Points (TRxPs) or TRPs, and so forth, and can comprise ground stations (e.g., terrestrial access points) or satellite stations providing coverage within various geographic areas (e.g., a cells). According to various aspects, the BSs can be implemented as one or more of a physical device such as a macrocell base station and/or a low power (LP) base station for providing femtocells, picocells, or other like cells having smaller coverage areas, smaller user capacity, or higher bandwidth compared to macrocells.

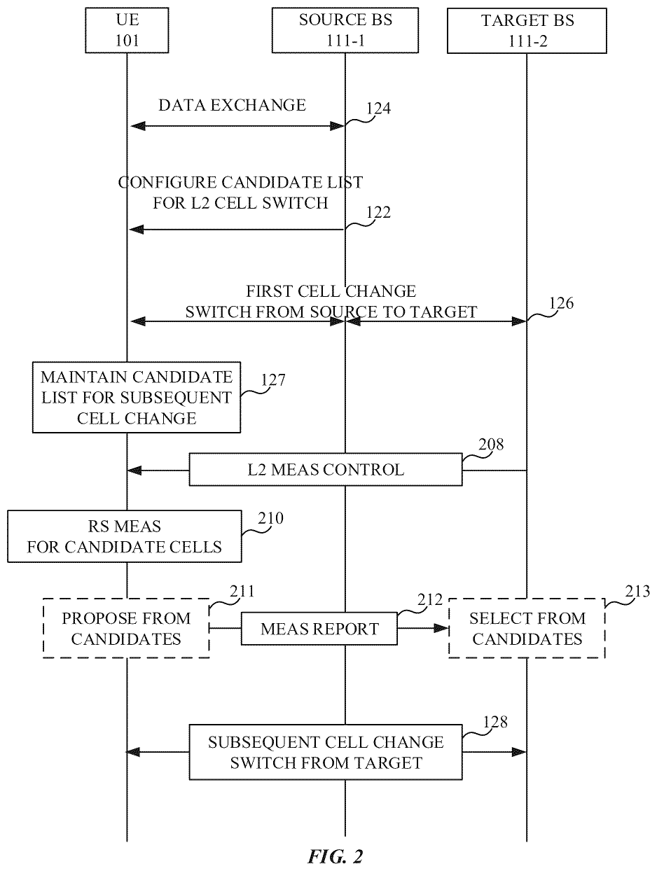

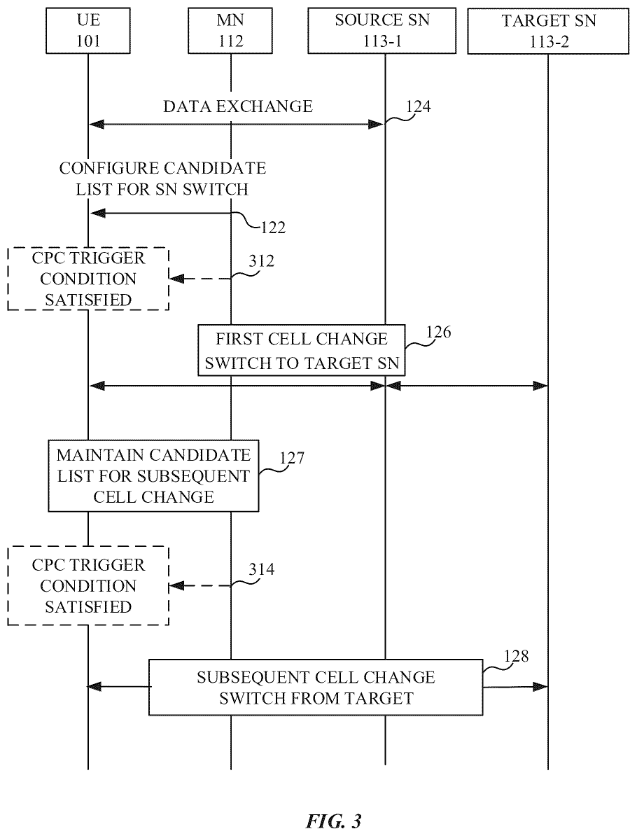

FIGS. 2-3 are schematic diagrams respectively illustrating a signaling example for L2 mobility and SN switch for a cell change procedure applying candidate configuration techniques described herein. In some aspects, the subsequent cell change can be, for example, a L2 based cell switch from a source Primary Cell (PCell) to a target PCell. In other aspects, the cell change can be a switch of a Master Node (MN) with a Master Cell Group (MCG) and/or a change or addition of a Secondary Node (SN) with Secondary Cell Group (SCG). In some aspects, the candidate configurations may include conditional triggering configurations such that Conditional Handover (CHO), Conditional PSCell Change (CPC), or Conditional PSCell Addition (CPA) that can be triggered or executed when the corresponding condition is met.

As shown in an example of FIG. 2, a sequential L1/L2 cell change between candidates without RRC reconfiguration can be supported. As shown by act 124, the UE 101 is in data communication with the source BS 111-1. As shown by act 122, the UE 101 receives configuration information from Network, including configurations of serving cell groups and candidate cells for a cell change. In some aspects, the configuration information may be transmitted by the source BS 111-1. In some alternative aspects, the configuration information may be received from another previous BS and maintained by the UE 101. In some aspects, the configuration information is communicated via a RRC reconfiguration message or a cell group configuration message. The configuration information may be communicated via RRC signaling and used by multiple subsequent cell change procedures without involving additional RRC based reconfigurations. Thus, the configuration information is not only for a first cell change, but also for a subsequent L2 cell switches, for example.

As shown by act 126, after performing measurements for the candidate cells, a decision may be made to perform a first cell change to the target BS 111-2, if a switch condition is satisfied. The target BS 111-2 is selected from the list of candidate BSs provided in the configuration information to the UE 101 as described associated with act 122.

As shown by act 127, after the first cell change at act 126, rather than releasing configurations for the remaining candidate BSs and receiving new candidate cell configurations, the UE 101 maintains the configuration information including candidate configurations for the remaining candidate BSs for use in a subsequent cell change. In addition, a configuration of the source BS 111-1 is added as an additional candidate configuration for use in a subsequent cell change. In some aspects, the additional candidate configuration can use the same serving cell configuration of the source BS 111-1. In some further aspects, the additional candidate configuration can be a delta candidate configuration based on the serving cell configuration of the source BS 111-1 as a reference configuration. The delta candidate configuration may indicate configuration changes to derive a candidate configuration for the source BS 111-1.

As shown by act 210, the UE 101 continues to perform L1/L2 measurement on reference signals received from candidate cells for a subsequent cell change. The candidate cells are configured by the configuration information at act 122 and include the candidate configuration of the source BS 111-1 as the additional candidate. The measurements may be periodical or in response to control signal received from the target BS 111-2 as shown by act 208. The control signal may be transmitted via a MAC-CE, for example.

As shown by act 211 and act 213, if a subsequent cell change condition is satisfied, the UE 101 or the target BS 111-2 may request or instruct the subsequent cell change. The cell change request from the UE 101 may be transmitted together or separately with reporting measurement results as shown by act 212. The target BS 111-2 may determine the cell change in response to the cell change request and/or the measurement report received from the UE 101. If the source BS 111-1 satisfies the subsequent cell change condition, the previous source BS 111-1 can be selected as a new target BS.

As shown by act 128, the subsequent cell change may be performed by switching the connection of the UE 101 from the previous target BS 111-2 to a new target BS (which could be either the previous source BS 111-1 or a different candidate BS 111-C1 or 111-C2 as shown in FIG. 1). The subsequent cell change may be initiated by the previous target BS 111-2 after transmitting the instruction for the subsequent cell change. Alternatively, the subsequent cell change may be initiated by the target BS 111-2 after receiving an instruction acknowledgment transmitted by the UE 101.

As shown in an example of FIG. 3, a subsequent SCG change between candidates without RRC reconfiguration can be supported. At act 124, the UE 101 is in communication with a source SN 113-1. The source SN 113-1 may be added or changed with the UE 101 anchored to the MN 112. The MN 112 and the source SN 113-1 are connected via a network interface.

As shown by act 122, candidate configurations of a candidate list for SN switch may be transmitted by a Master Node (MN) 112 and received by the UE 101. The candidate configurations may be included in configuration information communicated via RRC signaling and used by multiple subsequent cell change procedures without involving additional RRC reconfiguration. Thus, the configuration information is not only for a first cell change, but also for subsequent cell changes. In addition, in some aspects, conditional mobility operations, such as Conditional PSCell Addition (CPA), or Conditional PSCell Change (CPC) can be supported.

The configuration information received at act 122 may include configurations of serving cell groups and candidate cells for a cell change, such as for a SN switch, CPA or CPC. The configuration information may be transmitted by the MN 112. In some aspects, the configuration information is communicated via RRC signaling and used by multiple subsequent cell change procedures without involving additional RRC reconfiguration.

At act 126, the UE 101 performs a first cell change to switch to the target SN 113-2. In some aspects, optionally, prior to executing the first cell change, the UE 101 receives a CPA/CPC command for the first cell change with a triggering condition and does not apply the command until the triggering condition is satisfied, as shown by act 312. When the triggering condition of the target SN 113-2 is met, the UE 101 executes the cell change to the target SN 113-2 at act 126.

At act 127, in some embodiments, after finishing the first cell change to the target SN 113-2, the UE 101 maintains and does not release the candidate configurations in the configuration information, and hence the UE 101 can perform a subsequent cell change without prior CPC/CPA reconfiguration and re-initialization from network. Thereby, the delay for the cell change (e.g. SCG change) and the signaling overhead are reduced. In addition, a candidate configuration of the source SN 113-1 is added as an additional candidate configuration for the subsequent cell change. In some aspects, the additional candidate configuration can use the same serving cell configuration of the source SN 113-1. In some further aspects, the additional candidate configuration can be based on the serving cell configuration of the source SN 113-1 as a reference configuration, and apply a delta configuration to derive a candidate configuration for the source SN 113-1.

At act 128, in some aspects, the subsequent cell change is performed to switch from the target SN 113-2 to a new target SN (not shown in the figure). As illustrated, in some aspects, optionally, the UE 101 receives a CPA/CPC command with a triggering condition and does not apply the command until the triggering condition is satisfied, as shown by act 314. When the triggering condition of the new target SN (not shown in the figure) is met, the UE 101 executes the subsequent cell change to switch from the target SN 113-2 to the new target SN at act 126.

The candidate cell configurations for cell change operations may be maintained by the UE to eliminate the need for L3 reconfiguration to improve efficiency and reduce latency. In one aspect, the UE is preconfigured to always include a serving cell as an additional candidate for a subsequent cell change. A serving cell configuration can be used as a candidate configuration of the serving cell as the additional candidate. In other aspects, an implicit indication to use the serving cell as an additional candidate, an explicit candidate configuration for the serving cell as an additional candidate, or a hybrid of indication and configuration may be included in the configuration information for indicating or deriving a candidate configuration for the serving cell as an additional candidate. Though most examples are given using L2 mobility or SN switch configurations for illustration purposes, it is appreciated other applicable mobility operations, such as CHO, CPC, CPA, or the like, are amenable to the disclosure herein.

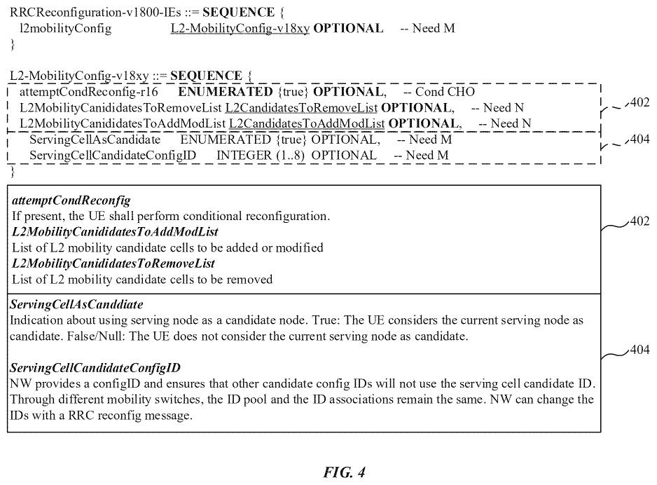

FIGS. 4-9 illustrate configuration examples using an implicit indication in configuration information to include a current serving cell (e.g., the source BS 111-1 or the source SN 113-1 as described associated with FIGS. 1-3) as an additional candidate for a subsequent cell change. If a serving cell candidate indicator is presented in the configuration information, a serving cell configuration may be used as a candidate configuration of the serving cell as an additional candidate.

In FIG. 4, an example of parameters related to including a serving cell as an additional cell change candidate is provided. In some aspects, configuration information of the serving cell as the additional cell change candidate is included in an RRC reconfiguration message. The RRC reconfiguration message includes a mobility configuration information element (IE), such as for L2 mobility or SN switch. Though a L2 mobility configuration is provided in FIG. 4 for illustration purpose, it is appreciated that configurations for other applicable mobility operations can be separately but similarly applied.

As shown in a first block 402, an L2 mobility configuration IE (e.g., L2mobilityconfiguration) may optionally include a candidate add/modify parameter (e.g., L2MobilityCanididatesToAddModList) and/or a candidate removal parameter (e.g., L2MobilityCanididatesToRemoveList). The candidate add/modify parameter lists L2 mobility candidate cells to be added or modified. The candidate removal parameter lists L2 mobility candidate cells to be removed. In some aspects for conditional procedures such as CHO, CPC, or CPA, a condition parameter attemptCondReconfig is also included. If the conditional parameter is presented (e.g., indicated as “true”), a conditional reconfiguration shall be triggered. In some further aspects, other parameters can be included in the mobility configuration, such as a trigger configuration ID, etc.

As shown in a second block 404, in some aspects, the L2 mobility configuration IE includes an indicator (e.g., ServingCellAsCandidate), indicating to use the serving cell configuration as a candidate configuration of the serving cell as the additional candidate. If the ServingCellAsCandidate indicator is presented (e.g., indicated as “true”), the UE considers the current serving node as a candidate. If the ServingCellAsCandidate indicator is not presented (e.g., absent or indicated as “false”), the UE does not consider the current serving node as a candidate.

In some additional aspects also shown in the second block 404, the L2 mobility configuration IE may include a fixed configuration identity (ID) (e.g., ServingCellCandidateConfigID) that is associated with the serving cell as the additional candidate. The fixed configuration ID is not used by other candidate configurations. Through different mobility switches, the ID pool and the ID associations remain the same. Network can change the IDs with a RRC reconfiguration message.

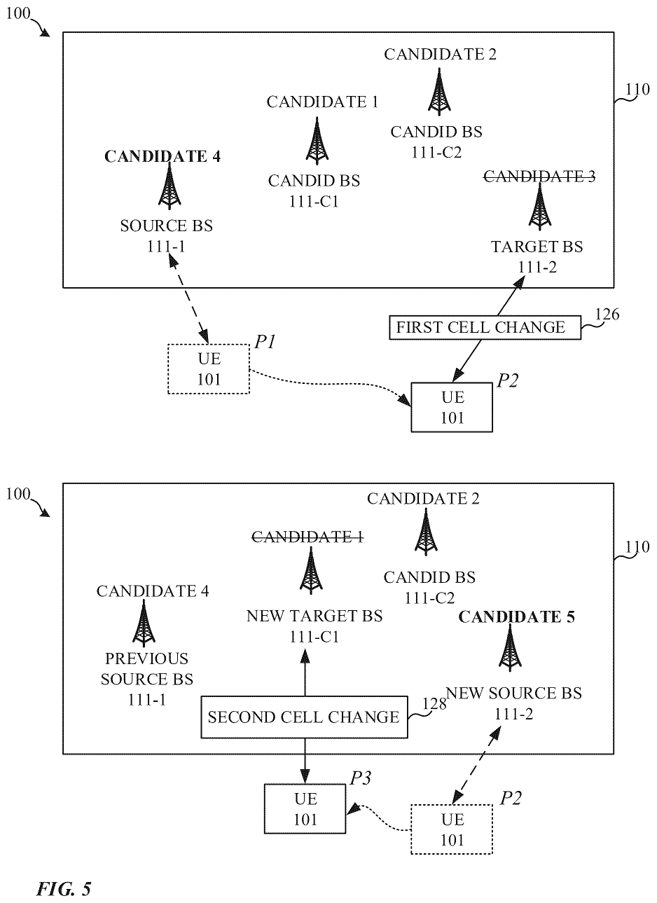

FIG. 5 provides an example of assigning dedicate candidate configuration IDs to serving cell candidates in accordance with various aspects. FIG. 5 uses the network system 100 shown in FIG. 1 as an example. The upper diagram shows the assignment of candidate configuration IDs after a first cell change as shown by act 126, while the lower diagram shows the assignment of candidate configuration IDs after a second cell change as shown by act 128.

As described associated with FIG. 1, when the UE 101 moves away from the source BS 111-1, a decision may be made to perform the first cell change to a target BS 111-2, as shown by act 126. The target BS 111-2 is selected from a list of candidate BSs configured to the UE 101. As an example, the list of candidate BSs includes BSs 111-C1, 111-C2, 111-2 respectively configured as Candidate 1, Candidate 2, and Candidate 3.

After the first cell change at act 126, Candidate 3 may be removed from the candidate list since the target BS 111-2 is connected to the UE 101. Then, rather than releasing configurations for the remaining candidate BSs Candidate 1 (111-C1) and Candidate 2 (111-C2), and receiving all new candidate cell configurations, the UE 101 maintains the configurations for the remaining candidate BSs Candidate 1 (111-C1) and Candidate 2 (111-C2), such that the latency, overhead, and interruption time associated with the RRC signaling of a L3-based mobility management is reduced. In addition, the source BS 111-1 is added as an additional candidate for the subsequent cell change. A fixed configuration ID, e.g., Candidate 4, is assigned to a candidate configuration of the source BS 111-1 as the additional candidate, so Candidate 4 (candidate configuration of the source BS 111-1) can be considered by subsequent cell changes.

When the UE 101 moves away from the new source BS 111-2, a decision may be made to perform a second cell change to a new target BS, 111-C1, for example. The new target BS 111-C1 is selected from the candidate list of Candidate 1, Candidate 2, and Candidate 4 as described above. Then, for a subsequent cell change, Candidate 1 may be removed from the candidate list since the new target BS 111-C1 is connected to the UE 101. The UE 101 maintains Candidate 2 and Candidate 4, and adds a candidate configuration for the new source BS 111-2, and assigns a fixed configuration ID, Candidate 5 for example, to the candidate configuration for the new source BS 111-2. Thus, through different mobility switches, the candidate configuration ID pool and the ID associations remain the same.

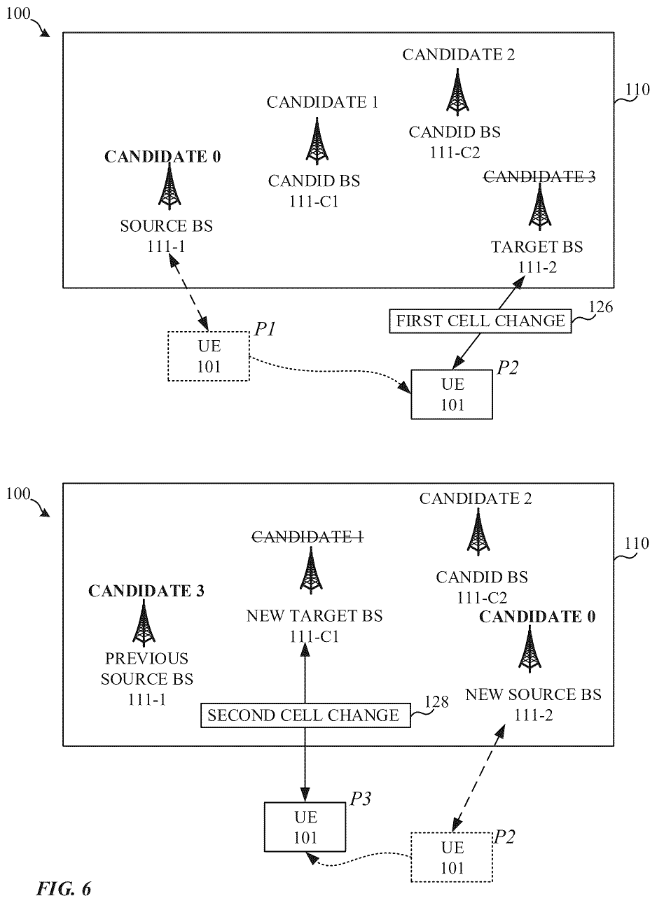

FIG. 6 provides an example of assigning a dedicated candidate configuration ID to a current serving cell candidate in accordance with various aspects. The current serving cell candidate configuration ID can be set to a dedicated candidate configuration ID (e.g., 0), and the dedicated candidate configuration ID is not used by other candidate configurations. When there is a switch, the candidate configuration IDs are swapped between a previous target cell and a previous source cell. More specifically, the candidate ID which was used by the previous target cell will be taken by the previous source BS, and the previous target cell now uses the dedicated candidate configuration ID as the candidate configuration ID. A more specific example is provided in FIG. 6 to illustrate the ID swap. FIG. 6 uses the network system 100 shown in FIG. 1 as an example. The upper diagram shows the assignment of candidate configuration IDs after a first cell change as shown by act 126, while the lower diagram shows the assignment of candidate configuration IDs after a second cell change as shown by act 128.

As described associated with FIG. 1, when the UE 101 moves away from the source BS 111-1, a decision may be made to perform the first cell change to a target BS 111-2. The target BS 111-2 is selected from a list of candidate BSs configured to the UE 101. As an example, the list of candidate BSs includes BSs 111-C1, 111-C2, 111-2 respectively configured as Candidate 1, Candidate 2, and Candidate 3.

After the first cell change at act 126, Candidate 3 may be removed from the candidate list since the target BS 111-2 is connected to the UE 101. Then, rather than releasing configurations for the remaining candidate BSs Candidate 1 (111-C1) and Candidate 2 (111-C2), and receiving all new candidate cell configurations, the UE 101 maintains the configurations for the remaining candidate BSs Candidate 1 (111-C1) and Candidate 2 (111-C2), such that the latency, overhead, and interruption time associated with the RRC signaling of a L3-based mobility management is reduced. In addition, the source BS 111-1 is added as an additional candidate for the second cell change. A dedicated configuration ID, e.g., Candidate 0, is assigned to a candidate configuration of the source BS 111-1 as the additional candidate, so the candidate configuration of the source BS 111-1 can be considered by subsequent cell changes.

When the UE 101 moves away from the new source BS 111-2, a decision may be made to perform the second cell change to a new target BS, 111-C1, for example. The new target BS 111-C1 is selected from the candidate list of Candidate 1, Candidate 2, and Candidate 0 as described above. Then, for a subsequent cell change, Candidate 1 may be removed from the candidate list since the new target BS 111-C1 is connected to the UE 101. Additionally, the candidate configuration ID Candidate 3, which was used by the previous target BS 111-2 is used to identify the previous source BS 111-1. The previous target BS 111-2, i.e., the new source BS, now uses the dedicated candidate configuration ID “Candidate 0’ as the candidate configuration ID for the serving cell. Assigning a dedicated candidate configuration ID to the current serving cell may be less efficient, since the candidate configuration ID pool and the ID associations changes through different mobility switches.

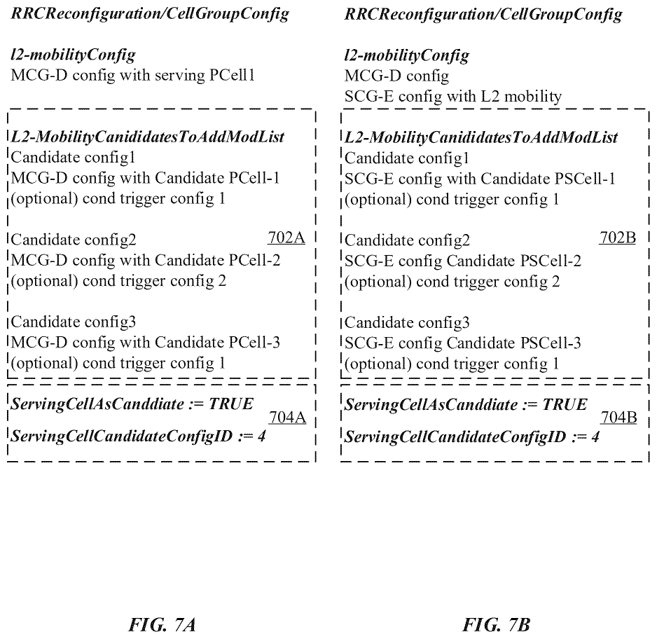

FIGS. 7A-7B illustrate examples of a serving configuration of a serving cell and candidate configurations of a list of candidates for L2 mobility in accordance with various aspects. The configurations for the serving cell and the candidate list can be either with IE RRCReconfiguration or IE CellGroupConfig, for example.

As shown in FIG. 7A, the serving configuration of the serving cell may include a MCG configuration with a serving cell (e.g. MCG-D config with serving PCell). The configurations of the candidate list may be included in the candidate list add/modify parameter (e.g., L2MobilityCanididatesToAddModList) as described associated with FIG. 4. The configurations of the candidate list may include various MCG configurations associated with candidate configuration IDs. For example, as shown in block 702A, Candidate config1 can include a first MCG configuration (MCG-D config with candidate PCell-1); Candidate config2 can include a second MCG configuration (MCG-D config with candidate PCell-2); and Candidate config3 can include a third MCG configuration (MCG-D config with candidate PCell-3). In some further aspects, other parameters can be included in the mobility configuration, such as a trigger configuration ID, etc. In some aspects for conditional procedures such as CHO, one or more condition parameters (cond trigger config 1, cond trigger config 2) may also be included and associated with the candidate configuration IDs. If the conditional parameters are presented, a conditional reconfiguration shall be triggered.

As shown in FIG. 7B, the configuration of the serving cell may include a MCG configuration (e.g. MCG-D config) and a SCG configuration with L2 mobility (e.g. SCG-E config). The candidate configurations of the candidate list may include various SCG configurations associated with candidate configuration IDs. For example, as shown in block 702B, Candidate config1 can include a first SCG configuration (SCG-E config with candidate PSCell-1); Candidate config2 can include a second SCG configuration (SCG-E config with candidate PSCell-2); and Candidate config3 can include a third SCG configuration (SCG-E config with candidate PSCell-3). In some aspects for conditional procedures such as CHO, one or more condition parameters (cond trigger config 1, cond trigger config 2) may also be included and associated with the candidate configuration IDs. If the conditional parameters are presented, a conditional reconfiguration shall be triggered.

In some aspects, a candidate configuration of the serving cell as an additional cell change candidate is included. For example, as shown in block 704A or 704B, in some aspects, the L2 mobility configuration IE may include an indicator (e.g., ServingCellAsCandidate). The indicator ServingCellAsCandidate is to indicate using the serving cell as an additional candidate. If the indicator ServingCellAsCandidate is presented (e.g., indicated as “true”), the UE considers the current serving node as a candidate. If the ServingCellAsCandidate indicator is not presented (e.g., absent or indicated as “false”), the UE does not consider the current serving node as a candidate.

In some additional aspects also shown in block 704A or 704B, the L2 mobility configuration IE may include a fixed configuration identity (ID) (e.g., ServingCellCandidateConfigID) that is associated with the serving cell as the additional candidate. The fixed configuration ID is not used by other candidate configurations. Through different mobility switches, the ID pool and the ID associations remain the same. Network can change the candidate configuration IDs with a RRC reconfiguration message.

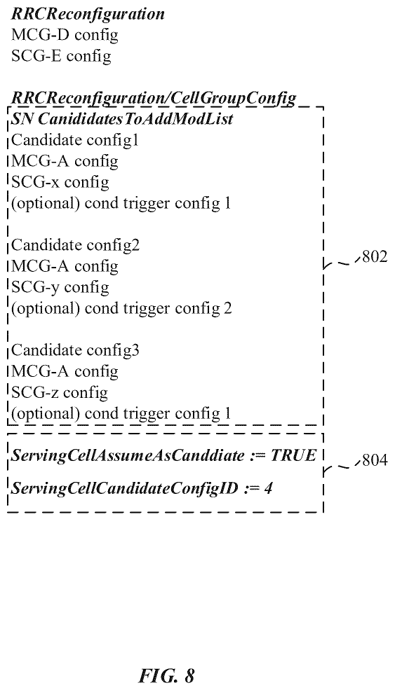

FIG. 8 illustrates another example of a serving configurations of a serving cell and candidate configurations of a list of candidates for SN switch in accordance with various aspects. The serving configuration for the serving cell can be with IE RRCReconfiguration, for example. The candidate configurations for the candidate list can be either with IE RRCReconfiguration or IE CellGroupConfig, for example. As shown in FIG. 8, the configuration of the serving cell may include a MCG configuration (e.g. MCG-D config) and a SCG configuration (e.g. SCG-E config). The configurations of the candidate list may include various MCG and SCG configurations associated with candidate configuration IDs.

For example, as shown in block 802, Candidate config1 can include a MCG configuration (MCG-A config) and a first SCG configuration (SCG-x config); Candidate config2 can include the MCG configuration (MCG-A config) and a second SCG configuration (SCG-y config); and Candidate config3 can include the MCG configuration (MCG-A config) and a third SCG configuration (SCG-z config). As another example for SN switch only, MCG configuration may stay as MCG-D not be changed, and the candidate configurations may only include candidate configurations for SCG. In some aspects for conditional procedures such as CHO, one or more condition parameters (cond trigger config 1, cond trigger config 2) may also be included and associated with the candidate configuration IDs. If the conditional parameters are presented, a conditional reconfiguration shall be triggered. The candidate configurations of the candidate list may be included in the candidate add/modify parameter (e.g., SNSwithchCanididatesToAddModList) similar as as described associated with FIG. 4.

In some aspects, a candidate configuration of the serving cell as an additional cell change candidate is included. For example, as shown in block 804, in some aspects, the SN switch configuration IE may include an indicator (e.g., ServingCellAsCandidate). The indicator ServingCellAsCandidate is to indicate using the serving cell as an additional candidate. If the indicator ServingCellAsCandidate is presented (e.g., indicated as “true”), the UE considers the current serving node (e.g., both MCG-D config and SCG-E config) as a candidate. If the ServingCellAsCandidate indicator is not presented (e.g., absent or indicated as “false”), the UE does not consider the current serving node as a candidate.

In some additional aspects also shown in block 804, the SN switch configuration IE may include a fixed configuration identity (ID) (e.g., ServingCellCandidateConfigID) that is associated with the serving cell as the additional candidate. The fixed configuration ID is not used by other candidate configurations. Through different mobility switches, the ID pool and the ID associations remain the same. Network can change the candidate configuration IDs with a RRC reconfiguration message.

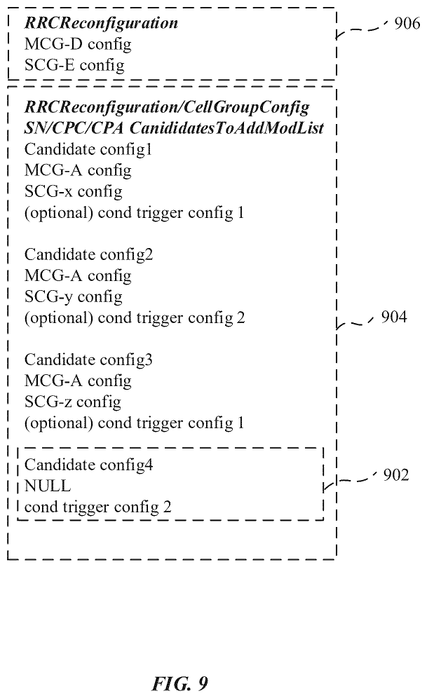

FIG. 9 illustrates a further configuration example using an implicit indication in configuration information to include a current serving cell (e.g., the source BS 111-1 or the source SN 113-1 as described associated with FIGS. 1-3) as an additional candidate for a subsequent cell change. In some aspects, a configuration parameter can be used as a serving cell candidate indicator. For example, for mobility operations involving a conditional triggering or executing, such as SN switch or conditional L2 mobility, if a conditional trigger/execution configuration is presented in the configuration information absent an explicit candidate configuration, it may imply that a source BS (e.g., the source BS 111-1 or the source SN 113-1 as described associated with FIGS. 1-3) is used as an additional candidate for a subsequent cell change. Thus, the conditional trigger/execution configuration is used as the serving cell candidate indicator. As shown in a block 902, the candidate configuration list 904 may include a conditional triggering configuration (e.g., cond trigger config 2) associated with a candidate configuration ID (e.g., Candidate config4), absent an explicit candidate configuration. Then, the serving cell configurations (e.g. MCG-D config, SCG-E config) shown in a block 906 can be used as candidate configurations for the serving cell (e.g., the source BS).

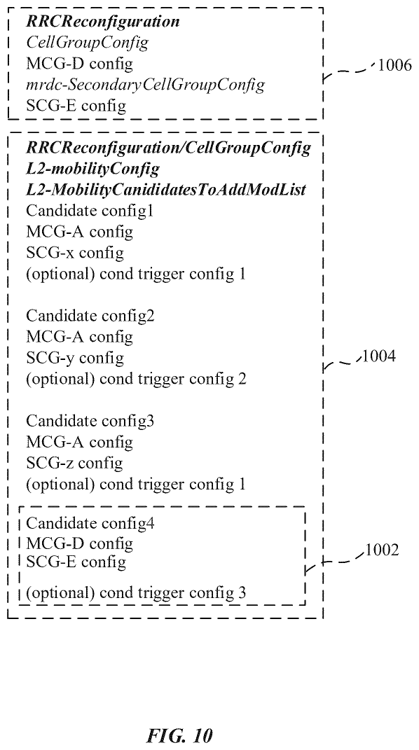

FIG. 10 illustrates a configuration example using explicit candidate configurations for a current serving cell as the additional candidate. The current serving cell can be the source BS 111-1 or the source SN 113-1 as described associated with FIGS. 1-3, for example. As shown in a block 1002, the explicit candidate configurations (e.g., MCG-D config, SCG-E config) are included in the candidate configuration list as shown in a block 1004. The explicit candidate configuration may be associated with a candidate configuration ID (e.g., Candidate config4) and may optionally be further associated with a conditional triggering configuration (e.g., cond trigger config 3) for conditional operations. In some aspects, the explicit candidate configurations are the same as the serving cell configurations (e.g. MCG-D config, SCG-E config) shown in a block 1006. In other aspects, the explicit candidate configurations are different from the serving cell configurations, though the serving cells are used as the additional candidates cells.

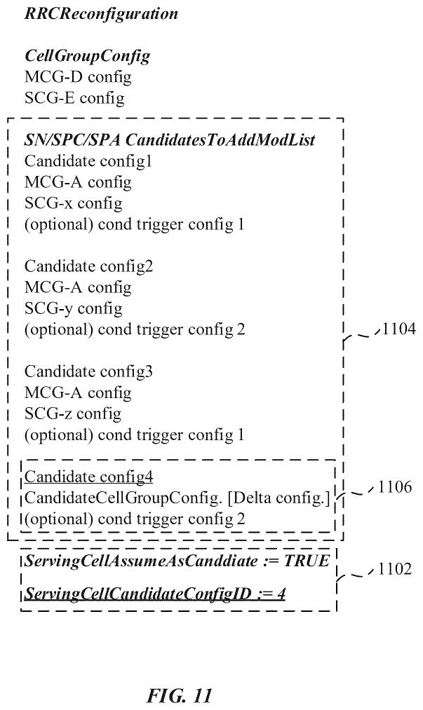

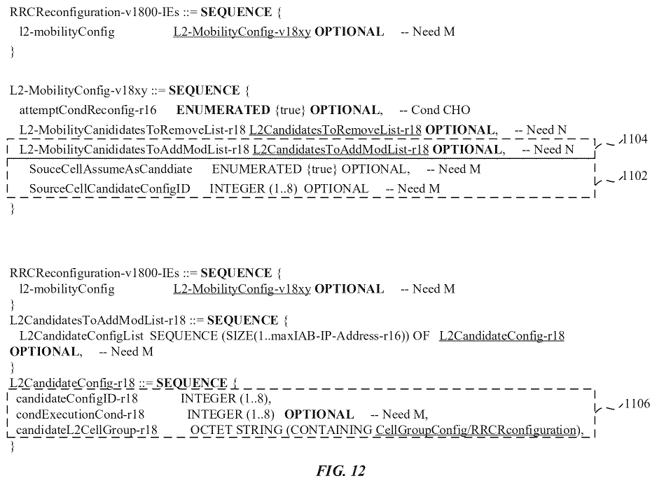

FIGS. 11-12 illustrate configuration examples using a hybrid of implicit and explicit candidate configurations for a current serving cell as the additional candidate. The current serving cell can be the source BS 111-1 or the source SN 113-1 as described associated with FIGS. 1-3, for example. In some aspects, the additional candidate configuration can use the serving cell configuration as a reference, and apply configuration changes to derive a candidate configuration. The derived candidate configuration is different from the previous serving cell configuration, and thus can provide improved security.

For example, as shown in a block 1102, a serving cell candidate indicator (e.g., SouceCellAssumeAsCanddiate:=TRUE) is presented in the configuration information and associated with a sourcecellcandidateconfigID (e.g., Candidate config4). The serving cell configuration (e.g., MCG-D config, SCG-E config) may be used as a reference of a candidate configuration for the current serving cell as an additional candidate. As shown in a block 1106, an explicit candidate configurations (e.g., CandidateCellGroupConFigure [Delta conFigure]) is included in the candidate configuration list 1104. The explicit candidate configuration may be associated with a candidate configuration ID (e.g., Candidate config4) and may optionally be further associated with a conditional triggering configuration (e.g., cond trigger config 2) for conditional operations. In some aspects, the explicit candidate configuration is a delta candidate configuration. If the candidate configuration ID is the same as the sourcecellcandidateconfigID, the content in the explicit candidate configuration “replace” the current serving cell configuration, when considered as candidate. A candidate configuration can be derived from the serving cell configuration and the delta candidate configuration.

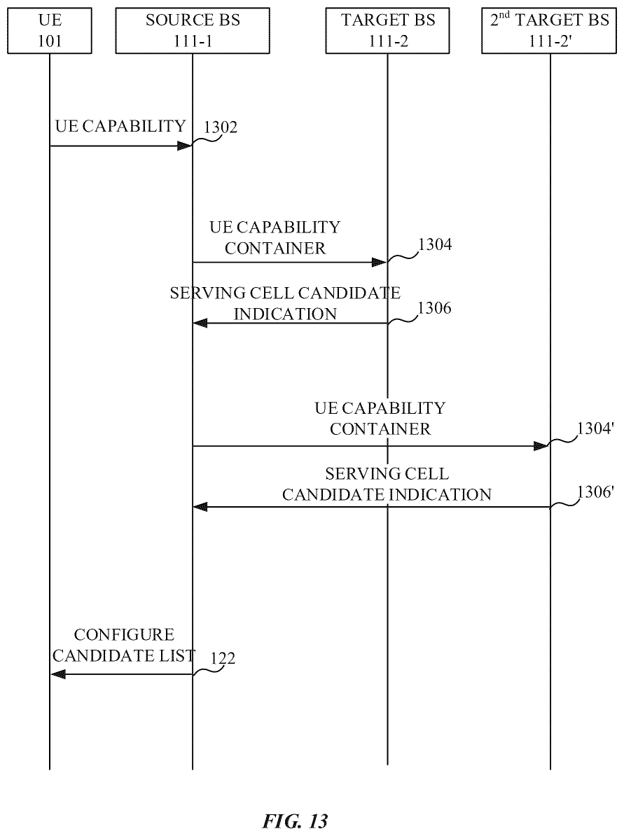

FIG. 13 is a schematic diagram illustrating signaling between a UE 101 and one or more BSs 111-1, 111-2 to communicate UE capability information. The UE capability information indicates a UE capability for including the current serving cell as a candidate for a subsequent cell change in accordance with some aspects of the present disclosure. In some aspects, the BS 111-1 can be a source BS such as a source gNB for L2 mobility or a MN or a source SN for SN switching. The BS 111-2 can be a target BS such as a target gNB or a target SN for SN switching. The BS 111-2′ can be an additional target BS such as a second target SN for SN switching.

As shown by act 1302, in some aspects, prior to receiving configuration information, the UE 101 may transmit UE capability information to the source BS 111-1. The UE capability information includes an indication of whether the UE 101 supports the serving cell as an additional candidate. The indication may be listed separately for different mobility operations. For example, a first indicating parameter, e.g., servingCellAsCandidateSupportL2Mobility, may be used to indicate whether the UE 101 supports using the serving cell as an L2 Mobility candidate. A second indicating parameter, e.g., servingCellAsCandidateSupportSNMobility, may be used to indicate whether the UE 101 supports using the serving cell as an SN switching candidate.

As shown by act 1304 and/or act 1304′, in some aspects, after receiving the UE capability information and prior to transmitting the configuration information, the source BS 111-1 may forward the UE capability information to one or more target BSs 111-2, 111-2′. The UE capability information may be forwarded via a UE capability container.

As shown by act 1306 and/or act 1306′, in some aspects, after receiving the UE capability information, the target BSs 111-2, 111-2′ may transmit indications of supporting the serving cell as the additional candidate to the source BS 111-1. The indications are based on the capability information. In some aspects, the target BSs 111-2, 111-2′ may also transmit candidate configurations to the source BS 111-1.

As shown by act 122, the source BS 111-1 transmits the configuration information to the UE 101. The configuration information may include a serving cell configuration and candidate configurations for a first cell change and a subsequent cell change. Whether the serving cell is configured as the additional candidate for the subsequent cell change is based on the UE capability information. The configuration information may be transmitted after receiving the indications of supporting the serving cell as the additional candidate from at least one of the target BSs 111-2, 111-2′.

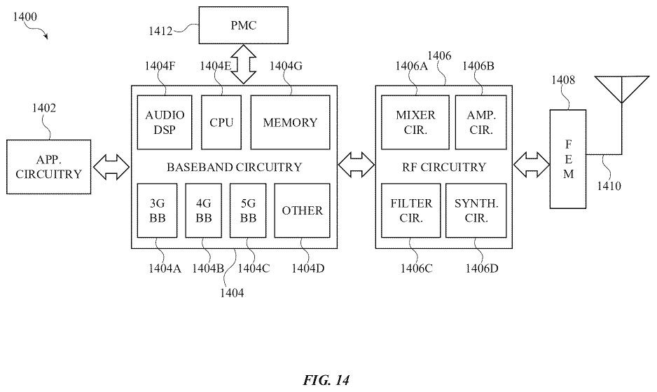

FIG. 14 is a diagram of an example of components of a device 1400 according to one or more implementations described herein. The device 1400 or its components can be or be included in a UE or a RAN node such as the UE 101 or the RAN 110, or BS 111-1, 111-2, 111-C1, 111-C2 etc., as described throughout this disclosure. In some implementations, the device 1400 can include application circuitry 1402, baseband circuitry 1404, RF circuitry 1406, front-end module (FEM) circuitry 1408, one or more antennas 1410, and power management circuitry (PMC) 1412 coupled together at least as shown. In some implementations, the device 1400 can include fewer elements (e.g., a RAN node may not utilize application circuitry 1402, and instead include a processor/controller to process IP data received from a CN such as 5GC or an Evolved Packet Core (EPC)). In some implementations, the device 1400 can include additional elements such as, for example, memory/storage, display, camera, sensor (including one or more temperature sensors, such as a single temperature sensor, a plurality of temperature sensors at different locations in device 1400, etc.), or input/output (I/O) interface. In other implementations, the components described below can be included in more than one device (e.g., said circuitries can be separately included in more than one device for Cloud-RAN (C-RAN) implementations).

The application circuitry 1402 can include one or more application processors. For example, the application circuitry 1402 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1400. In some implementations, processors of application circuitry 1402 can process IP data packets received from a CN.

The baseband circuitry 1404 can include circuitry such as, but not limited to, one or more single-core or multi-core processors. The baseband circuitry 1404 can include one or more baseband processors or control logic to process baseband signals received from a receive signal path of the RF circuitry 1406 and to generate baseband signals for a transmit signal path of the RF circuitry 1406. Baseband circuitry 1404 can interface with the application circuitry 1402 for generation and processing of the baseband signals and for controlling operations of the RF circuitry 1406. For example, in some implementations, the baseband circuitry 1404 can include a 3G baseband processor 1404A, a 4G baseband processor 1404B, a 5G baseband processor 1404C, or other baseband processor(s) 1404D for other existing generations, generations in development or to be developed in the future (e.g., 6G, etc.). The baseband circuitry 1404 (e.g., one or more of baseband processors 1404A-D) can handle various radio control functions that enable communication with one or more radio networks via the RF circuitry 1406. In other implementations, some or all of the functionality of baseband processors 1404A-D can be included in modules stored in the memory 1404G and executed via a Central Processing Unit (CPU) 1404E. The radio control functions can include, but are not limited to, signal modulation/demodulation, encoding/decoding, radio frequency shifting, etc. In some implementations, modulation/demodulation circuitry of the baseband circuitry 1404 can include Fast-Fourier Transform (FFT), precoding, or constellation mapping/de-mapping functionality. In some implementations, encoding/decoding circuitry of the baseband circuitry 1404 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, the baseband circuitry 1404 can include one or more audio digital signal processor(s) (DSP) 1404F. The audio DSPs 1404F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1404 and the application circuitry 1402 can be implemented together such as, for example, on a system on a chip (SOC).

In some implementations, the baseband circuitry 1404 can provide for communication compatible with one or more radio technologies. For example, in some implementations, the baseband circuitry 1404 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1404 is configured to support radio communications of more than one wireless protocol can be referred to as multi-mode baseband circuitry.

RF circuitry 1406 can enable communication with wireless networks using modulated electromagnetic radiation through a non-solid medium. In various implementations, the RF circuitry 1406 can include switches, filters, amplifiers, etc. to facilitate the communication with the wireless network. RF circuitry 1406 can include a receive signal path which can include circuitry to down-convert RF signals received from the FEM circuitry 1408 and provide baseband signals to the baseband circuitry 1404. RF circuitry 1406 can also include a transmit signal path which can include circuitry to up-convert baseband signals provided by the baseband circuitry 1404 and provide RF output signals to the FEM circuitry 1408 for transmission.

In some implementations, the receive signal path of the RF circuitry 1406 can include mixer circuitry 1406A, amplifier circuitry 1406B and filter circuitry 1406C. In some implementations, the transmit signal path of the RF circuitry 1406 can include filter circuitry 1406C and mixer circuitry 1406A. RF circuitry 1406 can also include synthesizer circuitry 1406D for synthesizing a frequency for use by the mixer circuitry 1406A of the receive signal path and the transmit signal path. In some implementations, the mixer circuitry 1406A of the receive signal path can be configured to down-convert RF signals received from the FEM circuitry 1408 based on the synthesized frequency provided by synthesizer circuitry 1406D. The amplifier circuitry 1406B can be configured to amplify the down-converted signals and the filter circuitry 1406C can be a low-pass filter (LPF) or band-pass filter (BPF) configured to remove unwanted signals from the down-converted signals to generate output baseband signals. Output baseband signals can be provided to the baseband circuitry 1404 for further processing. In some implementations, the output baseband signals can be zero-frequency baseband signals, although this is not a requirement. In some implementations, mixer circuitry 1406A of the receive signal path can comprise passive mixers, although the scope of the implementations is not limited in this respect.

In some implementations, the mixer circuitry 1406A of the transmit signal path can be configured to up-convert input baseband signals based on the synthesized frequency provided by the synthesizer circuitry 1406D to generate RF output signals for the FEM circuitry 1408. The baseband signals can be provided by the baseband circuitry 1404 and can be filtered by filter circuitry 1406C.

In some implementations, the output baseband signals and the input baseband signals can be analog baseband signals, although the scope of the implementations is not limited in this respect. In some alternate implementations, the output baseband signals and the input baseband signals can be digital baseband signals. In these alternate implementations, the RF circuitry 1406 can include analog-to-digital converter (ADC) and digital-to-analog converter (DAC) circuitry and the baseband circuitry 1404 can include a digital baseband interface to communicate with the RF circuitry 1406.

In some dual-mode implementations, a separate radio IC circuitry can be provided for processing signals for each spectrum, although the scope of the implementations is not limited in this respect.

FEM circuitry 1408 can include a receive signal path which can include circuitry configured to operate on RF signals received from one or more antennas 1410, amplify the received signals and provide the amplified versions of the received signals to the RF circuitry 1406 for further processing. FEM circuitry 1408 can also include a transmit signal path which can include circuitry configured to amplify signals for transmission provided by the RF circuitry 1406 for transmission by one or more of the one or more antennas 1410. In various implementations, the amplification through the transmit or receive signal paths can be done solely in the RF circuitry 1406, solely in the FEM circuitry 1408, or in both the RF circuitry 1406 and the FEM circuitry 1408.

In some implementations, the PMC 1412 can manage power provided to the baseband circuitry 1404. In particular, the PMC 1412 can control power-source selection, voltage scaling, battery charging, or DC-to-DC conversion. The PMC 1412 can often be included when the device 1400 is capable of being powered by a battery, for example, when the device is included in a UE. The PMC 1412 can increase the power conversion efficiency while providing desirable implementation size and heat dissipation characteristics. While FIG. 14 shows the PMC 1412 coupled only with the baseband circuitry 1404. However, in other implementations, the PMC 1412 may be additionally or alternatively coupled with, and perform similar power management operations for, other components such as, but not limited to, application circuitry 1402, RF circuitry 1406, or FEM circuitry 1408.

Processors of the application circuitry 1402 and processors of the baseband circuitry 1404 can be used to execute elements of one or more instances of a protocol stack. For example, processors of the baseband circuitry 1404, alone or in combination, can be used execute Layer 3, Layer 2, or Layer 1 functionality, while processors of the baseband circuitry 1404 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, Layer 2 can comprise a medium access control (MAC) layer, a radio link control (RLC) layer, and a packet data convergence protocol (PDCP) layer, and Layer 1 can comprise a physical (PHY) layer of a UE/RAN node.

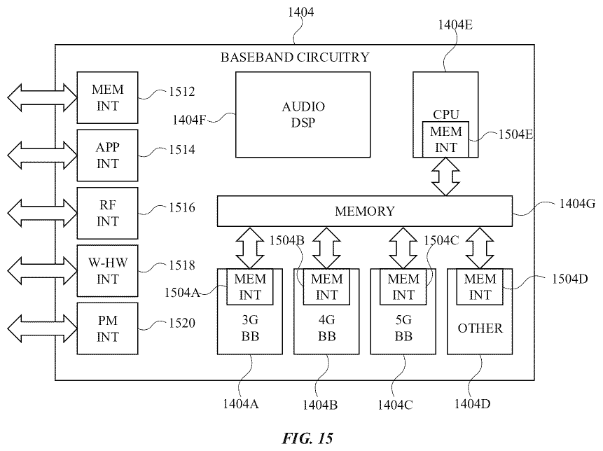

FIG. 15 is a diagram of example interfaces of baseband circuitry according to one or more implementations described herein. As discussed above, the baseband circuitry 1404 of FIG. 14 can comprise processors 1404A-1404E and a memory 1404G utilized by said processors. Each of the processors 1404A-1404E can include a memory interface, 1504A-1504E, respectively, to send/receive data to/from the memory 1404G.

The baseband circuitry 1404 can further include one or more interfaces to communicatively couple to other circuitries/devices, such as a memory interface 1512 (e.g., an interface to send/receive data to/from memory external to the baseband circuitry 1404), an application circuitry interface 1514 (e.g., an interface to send/receive data to/from the application circuitry 1402 of FIG. 14), an RF circuitry interface 1516 (e.g., an interface to send/receive data to/from RF circuitry 1406 of FIG. 14), a wireless hardware connectivity interface 1518 (e.g., an interface to send/receive data to/from Near Field Communication (NFC) components, Bluetooth components, Wi-Fi components, and other communication components), and a power management interface 1520 (e.g., an interface to send/receive power or control signals to/from the PMC 1412).

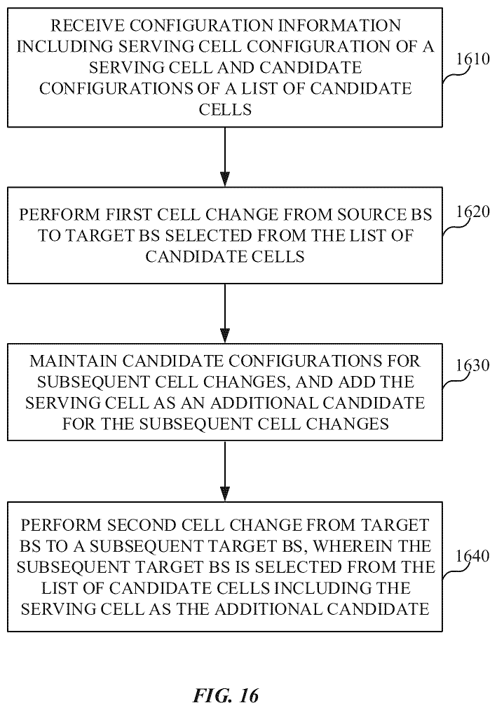

FIG. 16 is a process flow illustrating a cell change procedure for a UE to use a serving node as a candidate for subsequent cell changes in accordance with some aspects of the present disclosure. Some details and additional optional steps are already discussed above and may be referenced with other figures, and therefore may be omitted below for simplicity.

At act 1610, a configuration information is received. The configuration information may include a serving cell configuration of a serving cell and candidate configurations of a list of candidate cells. The configuration information may be transmitted by

At act 1620, a first cell change is performed from a source Base Station (BS) to a target BS. The target BS is selected from the list of candidate cells.

At act 1630, absent another reconfiguration message, the candidate configurations of the list of candidate cells are maintained for subsequent cell changes. In addition, the serving cell may be added to the list of candidate cells as an additional candidate for the subsequent cell changes. The serving cell may be added based on an implicit indicator parameter or an explicit addition of a candidate configuration. In some aspects, the candidate configuration for the serving cell as an additional candidate may be the serving configuration. In other aspects, the candidate configuration for the serving cell as an additional candidate may be a new candidate configuration with some parameters changed based on a delta configuration and using the serving configuration as a reference. The delta configuration may be included in the configuration information.

At act 1640, in some aspects, a second cell change may be performed from the target BS to a subsequent target BS. The subsequent target BS is selected from the list of candidate cells including the serving cell as the additional candidate.

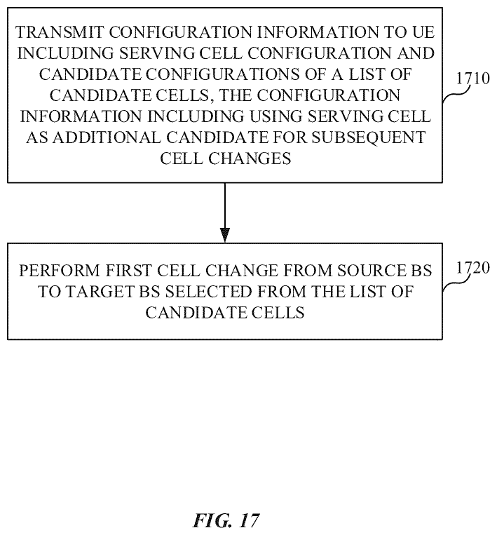

FIG. 17 is a process flow illustrating a cell change procedure for a Base Station (BS) to configure a serving node as a candidate for subsequent cell changes is accordance with some aspects of the present disclosure. Some details and additional optional steps are already discussed above and may be referenced with other figures, and therefore may be omitted below for simplicity.

At act 1710, configuration information is transmitted to a User Equipment (UE). The configuration information includes a serving cell configuration of a serving cell and candidate configurations of a list of candidate cells. As discussed in detail throughout the disclosure, the configuration information may include using the serving cell as an additional candidate for subsequent cell changes via various configuration techniques, such as implicit, explicit, or hybrid indicator parameters. In some aspects, the candidate configuration for the serving cell as an additional candidate may be the serving configuration. In other aspects, the candidate configuration for the serving cell as an additional candidate may be a new candidate configuration with some parameters changed based on a delta configuration and using the serving configuration as a reference. The delta configuration may be included in the configuration information.

At act 1720, a first cell change is performed from a source Base Station (BS) to a target BS. The target BS is selected from the list of candidate cells. The configuration information may configures the serving cell as an additional candidate added to the list of candidate cells for subsequent cell changes from the target BS.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is a UE, and comprising a memory and a processor coupled to the memory and configured to execute instructions stored in the memory to cause the UE to receive configuration information, the configuration information including a serving cell configuration of a serving cell and candidate configurations of a list of candidate cells, to perform a first cell change from a source Base Station (BS) to a target BS, wherein the target BS is selected from the list of candidate cells, to maintain the candidate configurations of the list of candidate cells for subsequent cell changes, and add the serving cell to the list of candidate cells as an additional candidate for the subsequent cell changes, and to perform a second cell change from the target BS to a subsequent target BS, wherein the subsequent target BS is selected from the list of candidate cells including the serving cell as the additional candidate.

Example 2 is a UE, including the subject matter of example 1, wherein the first cell change and the second cell change are Layer 2 (L2) based cell switches.

Example 3 is a UE, including the subject matter of example 1, wherein the first cell change and the second cell change are Secondary Node (SN) change or addition for Dual Connectivity (DC).

Example 4 is a UE, including the subject matter of example 1, wherein the configuration information further includes an indicator parameter, indicating to use the serving cell configuration as a candidate configuration of the serving cell as the additional candidate.

Example 5 is a UE, including the subject matter of example 4, wherein the configuration information further includes a fixed configuration ID that is used to identify the serving cell as the additional candidate.

Example 6 is a UE, including the subject matter of example 4, wherein the configuration information further includes a dedicated configuration ID to the candidate configuration of the serving cell as the additional candidate; and wherein the dedicated configuration ID is swapped with a candidate configuration ID of the target BS after the second cell change is performed.

Example 7 is a UE, including the subject matter of example 4, for SN switch or conditional L2 mobility, a conditional triggering configuration absent an explicit candidate configuration is used as the indicator parameter.

Example 8 is a UE, including the subject matter of example 1, wherein the candidate configurations of the list of candidate cells includes a delta candidate configuration for the serving cell as the additional candidate; and wherein a candidate configuration for the serving cell as the additional candidate is derived from the serving cell configuration and the delta candidate configuration.

Example 9 is a UE, including the subject matter of example 1, wherein one or more of Master Cell Group (MCG) configuration and Secondary Cell Group (SCG) configuration of the source BS that is related to L2 mobility or SN change is assumed as a candidate configuration for the source BS.

Example 10 is a UE, including the subject matter of example 1, wherein the configurations of the list of candidate cells include an explicit candidate configuration for the serving cell as the additional candidate.

Example 11 is a UE, including the subject matter of example 10, wherein the explicit candidate configuration of the serving cell is identified by a fixed candidate configuration ID not used by other candidate configurations.

Example 12 is a UE, including the subject matter of example 1, wherein the UE is preconfigured to use the serving cell configuration as a candidate configuration of the serving cell as the additional candidate.

Example 13 is a UE, including the subject matter of example 1, further configured to execute instructions from a memory to prior to receiving configuration information, transmit UE capability information to the source BS, wherein whether the serving cell is configured as the additional candidate for the subsequent cell changes is based on the UE capability information.

Example 14 is a BS, and comprising a memory and a processor coupled to the memory and configured to execute instructions stored in the memory to cause the BS to transmit configuration information to a User Equipment (UE), the configuration information including a serving cell configuration of a serving cell and candidate configurations of a list of candidate cells; and perform a first cell change to a target BS, the target BS is selected from the list of candidate cells; wherein the configuration information configures the serving cell as an additional candidate added to the list of candidate cells for subsequent cell changes from the target BS.

Example 15 is a BS, including the subject matter of example 14, further configured to, prior to transmitting the configuration information receive UE capability information from the UE, including whether the UE supports using the serving cell as the additional candidate, wherein whether the serving cell is configured as the additional candidate for the subsequent cell changes is based on the UE capability information.

Example 16 is a BS, including the subject matter of example 15, further configured to, after receiving the UE capability information and prior to transmitting the configuration information, forward the UE capability information to the list of candidate cells, receive the candidate configurations from the list of candidate cells, including indications of supporting the serving cell as the additional candidate, wherein whether supporting the serving cell as the additional candidate is based on the UE capability information, wherein the serving cell is configured as the additional candidate for the subsequent cell changes if supported by at least one serving cell of the list of candidate cells.

Example 17 is a BS, including the subject matter of example 14, wherein the configuration information further includes an indicator parameter, indicating to use the serving cell configuration as a candidate configuration of the serving cell as the additional candidate.

Example 18 is a BS, including the subject matter of example 14, wherein a conditional triggering configuration absent an explicit candidate configuration is used as the indicator parameter.

Example 19 is a BS, including the subject matter of example 14, wherein the configurations of the list of candidate cells include an explicit candidate configuration for the serving cell as the additional candidate.

Example 20 is a BS, including the subject matter of example 14, wherein the configurations of the list of candidate cells includes a delta candidate configuration for the serving cell as the additional candidate; and wherein a candidate configuration for the serving cell as the additional candidate is derived from the serving cell configuration and the delta candidate configuration.

Example 21 is a method for a user equipment (UE) to perform cell change operations, and comprising receiving configuration information, the configuration information including a serving cell configuration of a serving cell and candidate configurations of a list of candidate cells; performing a first cell change from a source Base Station (BS) to a target BS, wherein the target BS is selected from the list of candidate cells; and maintaining the candidate configurations of the list of candidate cells for subsequent cell changes, and adding the serving cell to the list of candidate cells as an additional candidate for the subsequent cell changes based on the configuration information.

Example 22 is a method, including the subject matter of example 21, wherein the configuration information includes an indicator parameter, indicating to use the serving cell configuration as a candidate configuration of the serving cell as the additional candidate.

Example 23 is a method, including the subject matter of example 21, a conditional triggering configuration absent an explicit candidate configuration is used as an indicator parameter, indicating to use the serving cell configuration as a candidate configuration of the serving cell as the additional candidate, if a condition of the conditional triggering configuration is satisfied.

Example 24 is a method, including the subject matter of example 21, further comprising performing a second cell change from the target BS to a subsequent target BS, wherein the subsequent target BS is selected from the list of candidate cells including the serving cell as the additional candidate.

Example 25 is a method, including the subject matter of example 21, wherein the candidate configurations of the list of candidate cells includes a delta candidate configuration for the serving cell as the additional candidate; and wherein a candidate configuration for the serving cell as the additional candidate is derived from the serving cell configuration and the delta candidate configuration.

Example 26 is a method that includes any action or combination of actions as substantially described herein in the Detailed Description.

Example 27 is a method as substantially described herein with reference to each or any combination of the Figures included herein or with reference to each or any combination of paragraphs in the Detailed Description.

Example 28 is a user equipment configured to perform any action or combination of actions as substantially described herein in the Detailed Description as included in the user equipment.

Example 29 is a network node configured to perform any action or combination of actions as substantially described herein in the Detailed Description as included in the network node.

Example 30 is a non-volatile computer-readable medium that stores instructions that, when executed, cause the performance of any action or combination of actions as substantially described herein in the Detailed Description.

Example 31 is a baseband processor of a user equipment configured to perform any action or combination of actions as substantially described herein in the Detailed Description as included in the user equipment.

Example 32 is a baseband processor of a network node configured to perform any action or combination of actions as substantially described herein in the Detailed Description as included in the user equipment.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor configured to execute instructions from a memory to:
receive configuration information, the configuration information including a serving cell configuration of a serving cell and candidate configurations of a list of candidate cells;
perform a first cell change from the serving cell to a first new serving cell selected from the list of candidate cells;
add the serving cell to the list of candidate cells as an additional candidate for subsequent cell changes; and
perform a second cell change from the first new serving cell to a subsequent new serving cell, wherein the subsequent new serving cell is selected from the list of candidate cells including the serving cell as the additional candidate.

2. The baseband processor of claim 1, wherein the first cell change and the second cell change are Layer 2 (L2) based cell switches.

3. The baseband processor of claim 1, wherein the first cell change and the second cell change are Secondary Node (SN) change or addition for Dual Connectivity (DC).

4. The baseband processor of claim 1, wherein the configuration information further includes an indicator parameter, indicating to use the serving cell configuration as a candidate configuration of the serving cell as the additional candidate.

5. The baseband processor of claim 1, wherein the configuration information further includes a configuration ID that is used to identify and add the serving cell as the additional candidate.

6. The baseband processor of claim 4,
wherein the configuration information further includes a dedicated configuration ID to the candidate configuration of the serving cell as the additional candidate; and
wherein the dedicated configuration ID is swapped with a candidate configuration ID of the first new serving cell after the second cell change is performed.

7. The baseband processor of claim 4, for SN switch or conditional L2 mobility, a conditional triggering configuration absent an explicit candidate configuration is used as the indicator parameter.

8. The baseband processor of claim 1,
wherein the candidate configurations of the list of candidate cells includes a delta candidate configuration for the serving cell as the additional candidate; and
wherein a candidate configuration for the serving cell as the additional candidate is derived from the serving cell configuration and the delta candidate configuration.

9. The baseband processor of claim 1, wherein one or more of Master Cell Group (MCG) configuration and Secondary Cell Group (SCG) configuration of the serving cell that is related to L2 mobility or SN change is assumed as a candidate configuration for the serving cell.

10. The baseband processor of claim 1, wherein the candidate configurations of the list of candidate cells include an explicit candidate configuration for the serving cell as the additional candidate.

11. The baseband processor of claim 10, wherein the explicit candidate configuration of the serving cell is identified by a candidate configuration ID not used by other candidate configurations.

12. The baseband processor of claim 1, wherein the processor is preconfigured to use the serving cell configuration as a candidate configuration of the serving cell as the additional candidate.

13. The baseband processor of claim 1, further configured to execute instructions from a memory to:
prior to receiving configuration information, transmit UE capability information to the serving cell; and
wherein whether the serving cell is configured as the additional candidate for the subsequent cell changes is based on the UE capability information.

14. A base station, comprising:
a memory; and
a processor coupled to the memory and configured to execute instructions stored in the memory to cause the base station to:
transmit configuration information to a User Equipment (UE), the configuration information including a serving cell configuration of a serving cell and candidate configurations of a list of candidate cells; and
perform a first cell change to a first new serving cell, the first new serving cell is selected from the list of candidate cells,
wherein the configuration information configures the serving cell as an additional candidate added to the list of candidate cells for subsequent cell changes from the first new serving cell.

15. The base station of claim 14, further configured to, prior to transmitting the configuration information:
receive UE capability information from the UE, including whether the UE supports using the serving cell as the additional candidate; and
wherein whether the serving cell is configured as the additional candidate for the subsequent cell changes is based on the UE capability information.

16. (canceled)

17. The base station of claim 14, wherein the configuration information further includes an indicator parameter, indicating to use the serving cell configuration as a candidate configuration of the serving cell as the additional candidate.

18. The base station of claim 17, wherein a conditional triggering configuration absent an explicit candidate configuration is used as the indicator parameter.

19. The base station of claim 14, wherein the candidate configurations of the list of candidate cells include an explicit candidate configuration for the serving cell as the additional candidate.

20. The base station of claim 14,
wherein the candidate configurations of the list of candidate cells includes a delta candidate configuration for the serving cell as the additional candidate; and
wherein a candidate configuration for the serving cell as the additional candidate is derived from the serving cell configuration and the delta candidate configuration.

21. A method for a User Equipment (UE) to perform cell change procedures, the method comprising:
receiving configuration information, the configuration information including a serving cell configuration of a serving cell and candidate configurations of a list of candidate cells;
performing a first cell change from the serving cell to a first new serving cell, wherein the first new serving cell is selected from the list of candidate cells; and
adding the serving cell to the list of candidate cells as an additional candidate for the subsequent cell changes based on the configuration information.

22-25. (canceled)
